(19) United States
(12) Patent Application Publication
(10) Pub. No.: US 2010/0191806 A1
(43) Pub. Date: Jul. 29, 2010

(54) STRUCTURE OF OBJECTS STORED IN A MEDIA SERVER AND IMPROVING ACCESSIBILITY TO THE STRUCTURE

(76) Inventors: Chang Hyun KIM, Seoul (KR); Ku Bong Min, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/753,770

(22) Filed: Apr. 2, 2010

Related U.S. Application Data
(63) Continuation of application No. 11/298,177, filed on Dec. 8, 2005.

(30) Foreign Application Priority Data
Dec. 9, 2004 (KR) 10-2004-0103768

(51) Int. Cl. G06F 15/16

(52) U.S. Cl. 709/203

(57) ABSTRACT

The present invention relates to providing media data in an open network system, wherein an object structure of a media server operationally connected to a Universal Plug and Play (UPnP) network is provided. The media server comprises a service for managing objects, and a storage unit for storing at least one object structure, the at least one object structure comprising at least one of a container and an item under a tree structure, wherein the at least one object structure comprises at least one object specified as a feature of the service. Preferably, the at least one object structure comprises at least one of a bookmark container and a shortcut container managed as a service feature.

### CROSS-REFERENCE TO RELATED APPLICATIONS

Pursuant to 35 U.S.C. §119(a), this application claims the benefit of earlier filing date and right of priority to Korean Application No. 10-2004-0103768, filed on Dec. 9, 2004, the contents of which is hereby incorporated by reference herein in its entirety.

### FIELD OF THE INVENTION

The present invention relates to allowing a user to easily recognize and access containers of a media server connected to an open network system, such as a universal plug and play (UPnP) network.

### BACKGROUND OF THE INVENTION

A universal plug and play (UPnP) network includes a control point (CP) for controlling a device and devices for providing services. The CP is capable of discovering and controlling different types of devices and receives and processes events through a provided interface.

Audio visual (AV) devices connected with the UPnP network include a media server 1a for providing media data and a media renderer 1b for reproducing media data, as shown in FIG. 1. The media server 1a and the media renderer 1b are controlled by the CP 1c. Media streaming 10 from the media server 1a is achieved based on generally known transport protocols.

The media server 1a allows the reading of information related to its own media files through a content directory service (CDS). Information contained in a media file includes the name, format, size, presentation time, URL, and type of the media file.

The CDS expresses objects belonging to the media server 1a in a tree structure, as shown in FIG. 2, through the CP 1c. The objects are classified into containers and items. The containers may contain information about other objects, while the items are information about media files.

In a current UPnP AV network, the highest-level object in the tree structure provided by the CDS, such as a root object 2a as shown in FIG. 2, is always expressed as “0” (character string). Moreover, the highest-level object has other children objects (i.e., containers and/or items). A general container may have other containers and other items as children objects thereof. In addition, all objects in one CDS are uniquely identified as specific character strings.

Since only both a root object identifier “0” and the structure shown in FIG. 2 are defined, the CP 1c calls a “Browse” action using “0” and “DirectChildren” as input arguments (reference numeral S1 in FIG. 1). As such, the CP 1c first performs browsing of the media server 1a with respect to the direct children of the “0” object (which is a predefined object ID recognized by the CP) in order to ultimately retrieve information about a media file of “Item 4” shown in FIG. 2 in the exemplary UPnP AV network. Accordingly, the CP 1c receives an XML-based result for the action call (reference numeral S2 in FIG. 1), obtains an object ID of “Container 1” from the result, and calls a “Browse” action in order to obtain direct children of the object “Container 1”. In the same manner, the CP 1c can obtain information about the “Item 4”, which is a child of the “Container 4” through a “Browse” action call. Herein, while performing the process, the object selection operation of a user is accompanied through the CP 1c.

However, even if the “Item 4” is a media file frequently used by the user, the above-described top-down selection of an object (i.e., a container) must continuously be performed whenever the CP 1c is operated or a control device is changed. Thus, the top-down selection causes a user to experience great inconvenience.

Therefore, in order to convenience the user when using a user interface, it is preferred that the CP 1c express objects in the form of graphics or icons, which can be easily recognized by a user. However, since there is no standardization defining types or properties of the objects, the CP 1c inevitably expresses character string information received from the media server 1a as is. This makes it difficult for the user to recognize the objects.

### SUMMARY OF THE INVENTION

The present invention is directed to providing media data in an open network system.

Accordingly, the present invention has been made to solve the above-mentioned problems occurring in the prior art, and an object of the present invention is to provide a management method allowing a user to easily access objects specified by the user.

Another object of the present invention is to provide a method for allowing an application such as a control point to identify a type or an attribute of each object.

According to one embodiment of the present invention, which allows a user to easily access an object, an object structure of a CDS comprises one object tree structure and a shortcut object separated from the tree structure.

In addition, according to one embodiment of the present invention, there is provided an action capable of registering and querying a featured object.

According to one embodiment of the present invention, a bookmark object and a shortcut object are managed as featured objects.

According to one embodiment of the present invention, which can identify each object type, an identifier of a media object, particularly, the container, that is, an object ID is defined and used as a character string capable of identifying a type of the media object.

According to another embodiment of the present invention, which can identify each object type, an identifier of a media object, particularly, the container, that is, an object ID is used as a predetermined character string, and type information capable of identifying a type of the media object is defined and used.

In accordance with one embodiment of the present invention, an apparatus operationally connected to an open network system for providing media data, comprises a service for managing objects, and a storage unit for storing at least one object structure, the at least one object structure comprising at least one of a container and an item under a tree structure, wherein the at least one object structure comprises at least one object specified as a feature of the service.

Preferably, the at least one object specified as a feature of the service is a bookmark container, wherein a plurality of bookmark containers are interconnected to each other under the tree structure. Preferably, an identifier of a bookmark item in a root container of the tree structure is written in a state variable. Alternatively, an identifier of a bookmark item, which is not in a root container of the tree structure, is not written in a state variable.

In one aspect of the invention, the at least one object specified as a feature of the service is an element of an object structure different from an object structure comprising files containing media data.

In another aspect of the invention, the at least one object specified as a feature of the service is an element of a sub-object structure, wherein the sub-object structure is an element of a container of an object structure comprising files containing media data.

In a further aspect of the invention, the at least one object specified as a feature of the service is a shortcut container. Preferably, the service is a content directory service defined in a Universal Plug and Play protocol.

In accordance with another embodiment of the invention, a method for providing media data in an open network system comprises providing a service for managing objects, providing a storage unit for storing at least one object structure in a storage unit, the at least one object structure comprising at least one of a container and an item under a tree structure, recording at least one object specified as a feature of the service in the storage unit, and writing information related to the at least one object specified as a feature of the service.

Preferably, the at least object specified as a feature of the service is a bookmark container.

In one aspect of the invention, the writing step comprises writing in a state variable an identifier for at least one bookmark item contained in the recorded at least one object specified as a feature of the service.

In another aspect of the invention, the writing step comprises writing in the state variable information related to a service name and a service version.

In a further aspect of the invention, the at least one object specified as a feature of the service is recorded under an object structure different from an object structure comprising files containing media data. Alternatively, the at least one object specified as a feature of the service is recorded in a sub-object structure, wherein the sub-object structure is an element of a container of an object structure comprising files containing media data.

In yet another aspect of the invention, the at least one object specified as a feature of the service is a shortcut container.

Preferably, the information related to the recorded at least one object specified as a feature of the service is written in the storage unit. Alternatively, the information related to the recorded at least one object specified as a feature of the service is written in a memory unit other than the storage unit.

Preferably, the service is a content directory service defined in a Universal Plug & Play protocol.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a block diagram illustrating a structure of a universal plug and play audio visual (UPnP AV) network.

FIG. 2 is a view illustrating an object structure of a media server connected with a UPnP AV network.

FIG. 3 is a view illustrating an action performed in a UPnP AV network in accordance with one embodiment of the present invention.

FIGS. 4a and 4b are views illustrating an object structure managed by a media server in accordance with one embodiment of the present invention.

FIG. 5 is a view illustrating type information of an object in accordance with one embodiment of the present invention.

FIGS. 6a and 6b are views illustrating object structures managed by a media server in accordance with one embodiment of the present invention.

FIG. 6c is a view illustrating a screen image displaying a container as an icon on a control point (CP) with respect to object structures as shown in FIGS. 6a and 6b.

FIG. 7 is a view illustrating an object structure managed by a media server in accordance with one embodiment of the present invention.

FIGS. 8a and 8b are views illustrating syntax of an action message for registering a predetermined object as a shortcut object and querying the shortcut object in accordance with one embodiment of the present invention.

FIG. 9 is a view illustrating an object structure in which a predetermined container is converted into a shortcut object in accordance with another embodiment of the present invention.

FIG. 10 is a view illustrating alternative syntax of an action message for registering an object as a shortcut object in accordance with another embodiment of the present invention.

FIG. 11 is a view illustrating an object structure in which a predetermined container is converted into a direct child container of a shortcut object in accordance with another embodiment of the present invention.

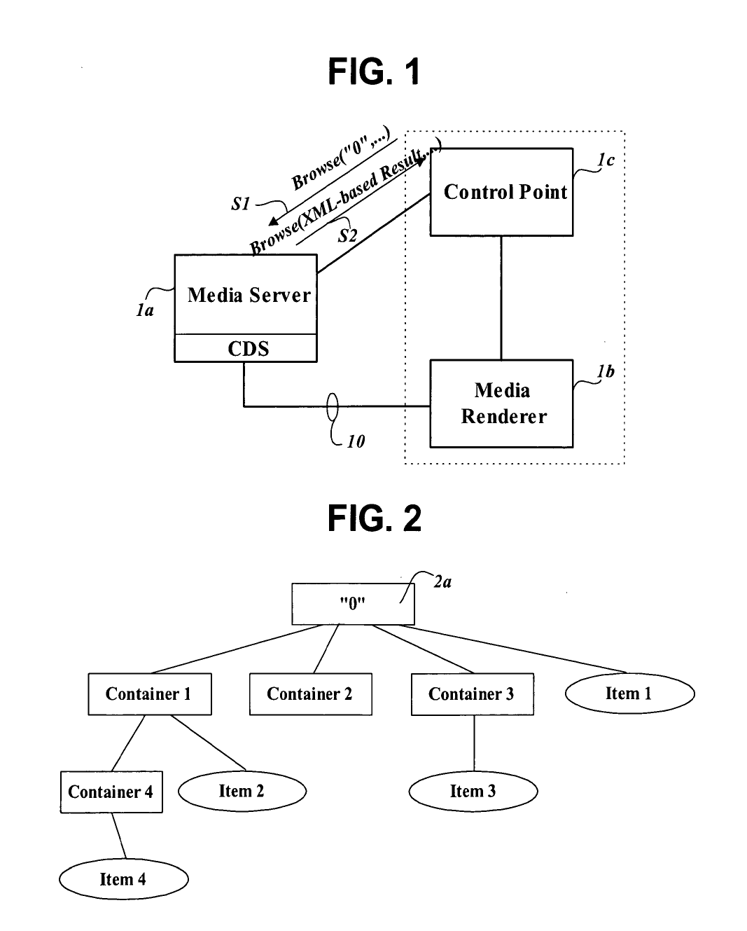

### DETAILED DESCRIPTION OF THE PREFERRED EMBODIMENTS

The present invention relates to providing media data in an open network system.

Hereinafter, preferred embodiments of the present invention will be described with reference to the accompanying drawings. In the following description and drawings, the same reference numerals are used to designate the same or similar components, and so repetition of the description on the same or similar components will be omitted.

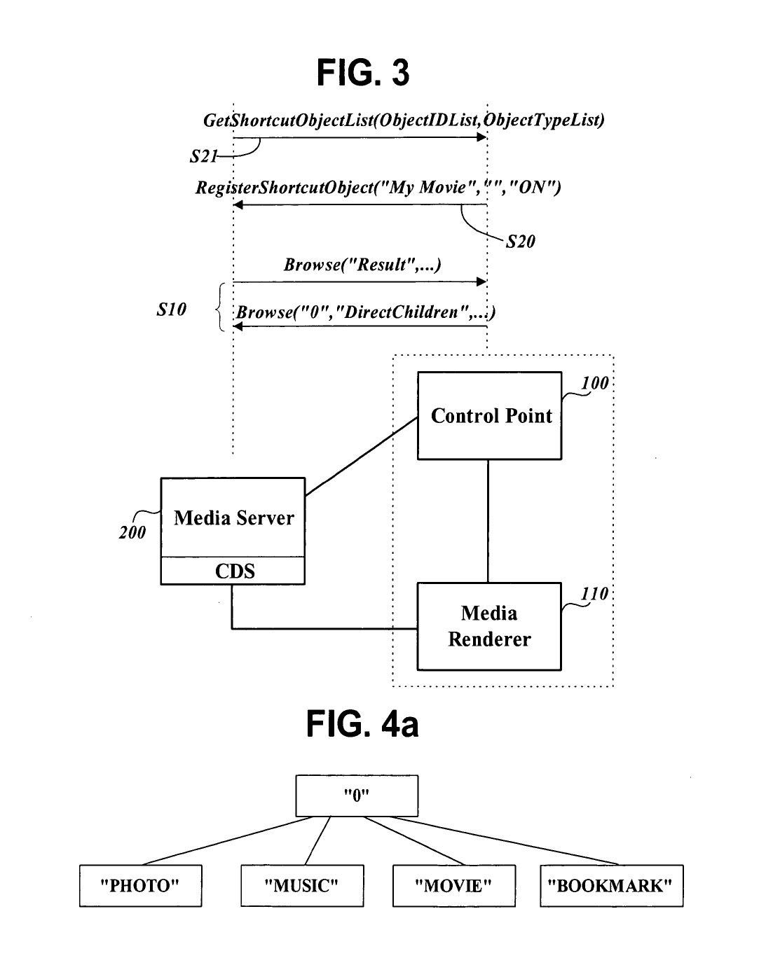

FIG. 3 illustrates a universal plug and play (UPnP) network in accordance with the present invention. The UPnP network comprises a media server 200, a control point (CP) 100, and a media renderer 110. The CP 100 and the media renderer 110 each may be a logical element, such as an application, and may coexist in one physical device, such as a personal computer (PC). In addition, a content directory service (CDS) in the media server 200 uses an identifier for identifying a pre-specified type for each container as an object ID of the container, or includes the identifier in type information.

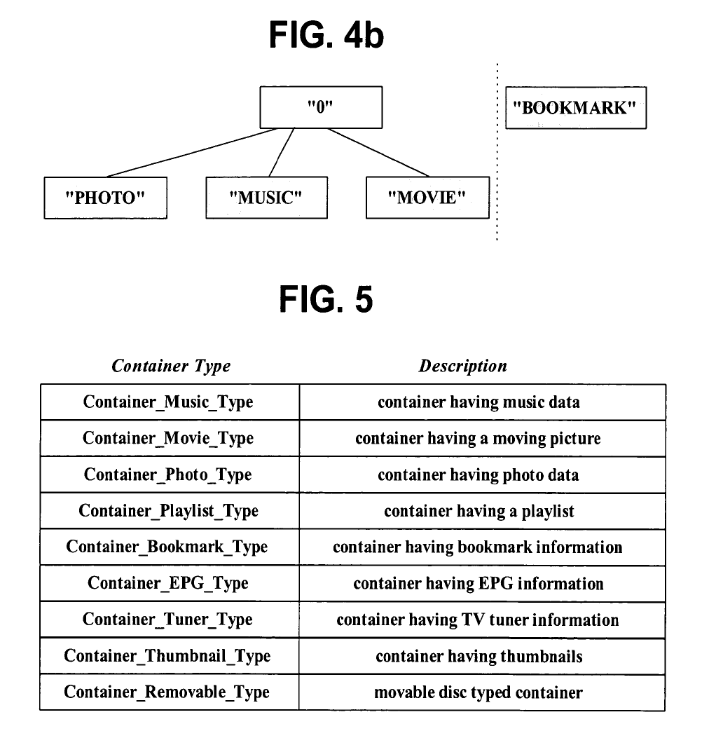

FIGS. 4a and 4b illustrate object structures having been stored in a storage unit (e.g., a hard disk) of the media server 200. In FIGS. 4a and 4b, container IDs are uniquely defined and used in order to identify media types in accordance with one embodiment of the present invention. A container ID “PHOTO” is specified for a container containing photo data. A container ID “MUSIC” is specified for a container containing music data. A container ID “MOVIE” is specified for a container containing moving picture data such as movies. A container ID “BOOKMARK” is specified for a bookmark container which stores a position of an object reproduced by a user and a reproduction history. Preferably, the container ID “BOOKMARK” is a feature of the CDS. Each container may contain sub-containers or items. Because the container IDs are exclusively allocated and used, and the defined IDs are already known to the CP 100 according to the present invention, the CP 100 may instantly recognize types of files included in a respective container by determining an object ID received through a “Browse” action, for example.

FIG. 4b illustrates an example in which the bookmark container, as an additional root container, is registered as a shortcut container in accordance with one embodiment of the present invention. Description regarding the shortcut container will be given below.

FIG. 5 illustrates an embodiment in which container IDs are freely defined and used, and type information enabling the identification of media types is uniquely defined. In the type information shown in FIG. 5, “Container_Playlist_Type” is defined for a container including a list of media data to be reproduced by a user, “Container_EPG_TYPE” is defined for a container including broadcasting program information, “Container_Tuner_Type” is defined for a container including broadcasting channel information, “Container_Thumbnail_Type” is defined for a container including thumbnails set up or specified by a user for the easy recognition of media data, and “Container Removable_Type” is defined for a container including information about mediums attachable to the media server 200. In addition, type IDs of various containers may be defined according to information about items included in the containers.

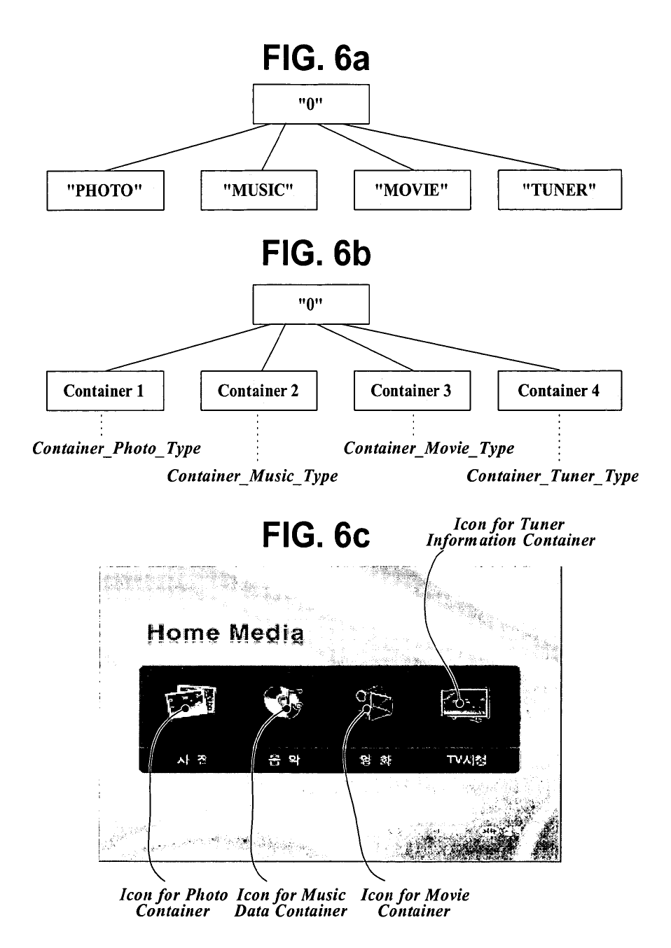

In the state in which container types have been defined according to an embodiment shown in FIG. 4a, 4b, or 5, if the CP 100 requests a browsing action and receives a result thereof, the CP 100 can display a suitable graphic or a suitable icon for each object stored in the CP 100 instead of displaying a character string for the object. For example, when the media server 200 has a CDS object structure shown in FIG. 6a or 6b, if the CP 100 requests, for example, a browsing action for direct children of the root container “0” to the media server 200 and then receives a result for the request (S10, as shown in FIG. 3), the CP 100 can recognize four container types, which are children objects of the root container, based on object IDs or type information of the objects.

Accordingly, the CP 100 reads out and displays graphic thumbnails (e.g., icons) according to types stored therein instead of expressing received containers of the direct children as character strings. FIG. 6c is one example of a browsing image output in accordance with the above-described procedure. If a user selects one icon, the CP 100 requests a browsing action for an object associated with the icon to the media server 200 and then receives the result for the request so as to display a media file item, a bookmark item, and/or sub containers on a screen.

The browsing action used in the above-described procedure for querying objects under a specific container is one example of the present invention. In another embodiment of the present invention, the CP 100 can search for objects specified as a service feature, such as “BOOKMARK”, through an additional action such as a feature querying action in addition to the browsing action. Featured objects managed by the CDS may comprise an Electronic Programming Guide (EPG) type and a TUNER type, as described above, in addition to a BOOKMARK type. Preferably, these featured objects are defined for reporting to the CP differently from general objects in order to efficiently use the CDS. If there is a feature supported by the CDS with respect to a feature querying action, the CDS can provide the name of the feature, a current version of the feature, and a list of objects under a root container among containers included in the feature as output arguments of the feature querying action. The CDS manages state variables about a predetermined service feature in order to respond to the feature querying action. Preferably, the state variables comprise a name of each feature, a version of the feature, and object IDs of a root container among containers belonging to the feature (e.g., object IDs of bookmark items if the service feature is a bookmark).

Hereinafter, a scheme for managing a “shortcut” according to a preferred embodiment of the present invention will be described.

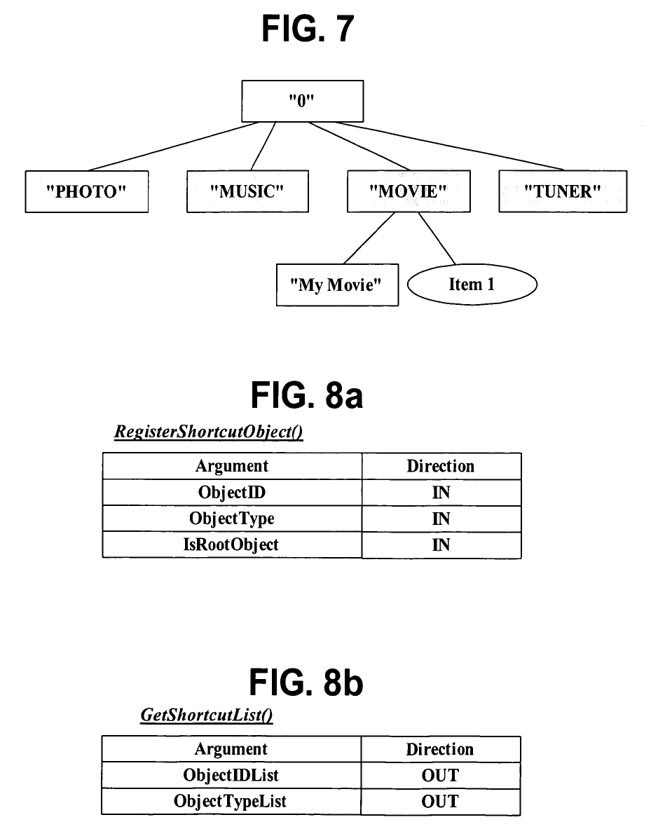

When an object structure shown in FIG. 7 is constructed in the media server 200, if a user selects a “My Movie” container and specifies the “My Movie” container as a shortcut container, the CP 100 calls the media server 200 for a shortcut registration action (reference numeral S20 shown in FIG. 3). Herein, since the shortcut object is not a generally managed object (e.g., a media object), but an exception, the CDS can manage the shortcut container as one service feature. The selection of the user is achieved through generally known input units such as a mouse or a remote controller.

Herein, the syntax of a called shortcut registration action message is shown in FIG. 8a. The name of the short cut registration action is “RegisterShortcutObject”. “ObjectId” is an identifier of an object to be registered as a shortcut object, “ObjectType” is a type of the object, and “IsRootObject” is information about a structure used for registering the object as a shortcut object. Types of the object employ the identifiers shown in FIG. 5 and are received from the media server 200 through browsing. However, the types of the object may be modified by the modification request of a user. In addition, the “IsRootObject” is an input argument indicating whether or not the structure is separated from a tree structure employing “0” as a root container and is specially managed. The value of the “IsRootObject” is determined based on user input information. The value “ON” of the “IsRootObject” indicates that the structure is separated from the conventional tree structure and has a container identical to the root container. The “OFF” value of the “IsRootObject” indicates that the structure is maintained.

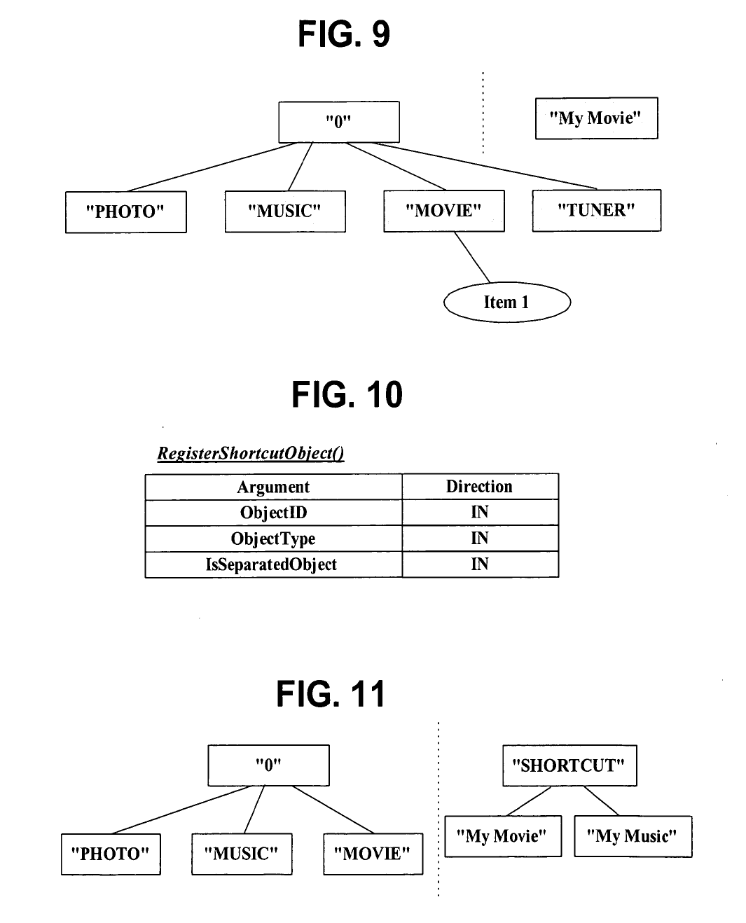

As described above, if the action of the “RegisterShortcutObject” is called for the “My Movie” container by setting the value of the “IsRootObject” as “ON”, the CDS of the media server 200 converts the object structure shown in FIG. 7 into an object structure shown in FIG. 9. To this end, parent information of the “My Movie” object is reset as “−1” such that the “My Movie” object becomes not a child of the “Movie” object any more. If an object structure is changed as shown in FIG. 9, it is difficult to access the “My Movie” container when the root object “0” is set as a starting point. If it is intended to access a shortcut object created as another root identical to the root object “0” as shown in FIG. 9, the CDS must be called through a browser action having the identifier of the object (i.e., “My Movie”) as an input argument. If the shortcut object is created as an additional root object as shown in FIG. 9, the shortcut object may be separated from containers having different characteristics and may be hidden because the shortcut object is not shown through a browsing action starting from the conventional root object “0”. If the user sets “IsRootObject” as “ON” with respect to another container (i.e., the “My Music” object) and calls the shortcut registration action, another root container is independently created like the “My Movie” object.

If the “RegisterShortcutObject” action is called by setting the value of the “IsRootObject” as “OFF”, the media server 200 stores information about the object (i.e., the “My Movie” object), which is called when the “RegisterShortcutObject” action is called, in a storage unit (e.g., a memory) as a shortcut item without changing the conventional tree structure. Objects to be registered as shortcut items by setting the value of the “IsRootObject” as “OFF” may be confirmed through, for example, a shortcut querying action (reference numeral S21 of FIG. 3).

In the meantime, if the “shortcut” is registered as one service feature by the CDS in the media server 200, the shortcut querying action is identical to the above-described feature querying action. Since the shortcut querying action specifies one feature and performs querying differently from the feature querying action, the shortcut querying action is a subset of the feature querying action.

Herein, the syntax of a response message for the shortcut querying action is shown in FIG. 8b. The name of the shortcut querying action is “GetShortcutObjectList”. An output argument “ObjectIDList” obtained by the “GetShortcutObjectList” includes IDs of objects registered as shortcut objects. Another output argument “ObjectTypeList” includes information about types of the objects. Each object ID and each type information are separated from each other using a comma and delivered. The media server 200 sees information about objects registered as shortcut objects having been previously stored in the storage unit in order to provide the output arguments to the CP 100. In case that a plurality of containers featured as shortcut objects are constructed in a tree structure, objects IDs under a shortcut root container are carried by the output argument “ObjectIDList” and delivered to the CP 100 through the shortcut querying action.

Although objects to be registered as shortcut objects are created in an additional root level according to the previous embodiment, a shortcut container (e.g., a container having “SHORTCUT” as an ID) may be separated from a tree structure of a default root container “0” and additionally defined. An object specified as a shortcut object may be registered as a child container of the shortcut container “SHORTCUT”. To this end, the third input argument of the “RegisterShortcutObject” action indicates whether the shortcut container is defined as an additional root object or belongs to the default root container “0” as an independent shortcut container. In other words, as shown in FIG. 10, the third input argument is used as the meaning of “IsSeparatedObject” and not the “IsRootObject”.

If the “IsSeparatedObject”=“OFF”, an object registered as the shortcut object stays in a current position of the conventional tree structure. If the “IsSeparatedObject”=“ON”, the object registered as the shortcut object is registered as a direct child of the additionally separated shortcut root container (“SHORTCUT”). In this embodiment, although a plurality of containers are registered as shortcut containers, because the containers are preferably registered as direct children of the shortcut container, as shown in FIG. 11, all objects registered as shortcut objects (e.g., objects under the shortcut root container) can be confirmed through invoking, for example, a browsing action to browse information about direct children of the shortcut container “SHORTCUT”. Specifically, a command of “Browse (”SHORTCUT”, “DirectChildren”)” may be used or a feature querying action may be invoked.

As described above, according to at least one embodiment of the present invention, an enhanced user interface such as a suitable graphic thumbnail is provided with respect to media data of media types widely used regardless of media server manufacturing companies, thereby enabling a user to easily recognize specific objects. In addition, it is possible for a user to quickly access objects mainly searched by the user through a shortcut function, thereby allowing the user to experience convenience for the use of media devices.

Although preferred embodiments of the present invention have been described for illustrative purposes, those skilled in the art will appreciate that various modifications, additions and substitutions are possible, without departing from the scope and spirit of the invention as disclosed in the accompanying claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1-19. (canceled)

20. A method for browsing an item associated with a supported function, the method performed by a controller and comprising:
transmitting a feature request to a server in order to obtain feature information stored in the server and associated with the function that is supported by the server, wherein the server provides a service that manages at least one container including at least one item and the feature information comprises a name of the supported function, a version of the supported function and a container identifier (ID), the container ID indicating a specific container among the at least one container that includes the item associated with the supported function;
receiving a feature response including the feature information from the server; and
transmitting a browsing request to the server, the browsing request including the container ID included in the feature information,
wherein the browsing request causes the server to browse the item associated with the supported function in the specific container indicated by the container ID included in the feature response.

21. The method of claim 20, wherein the supported function includes at least an electronic programming guide, a tuner or a bookmark.

22. The method of claim 20, further comprising receiving a result of the browsing from the server.

23. A controller for browsing an item associated with a function, the controller comprising:
an interface unit configured to at least receive or transmit data; and
a control unit configured to
generate a feature request in order to obtain feature information stored in a server and associated with the function that is supported by a server, wherein the server provides a service that manages at least one container including at least one item and the feature information comprises a name of the supported function, a version of the supported function and a container identifier (ID), the container ID indicating a specific container among the at least one container that includes the item associated with the supported function,
transmit the feature request to the server through the interface unit,
receive a feature response including the feature information from the server through the interface unit,
generate a browsing request including the container ID included in the feature information, and
transmit the browsing request to the server,
wherein the browsing request causes the server to browse the item associated with the supported function in the specific container indicated by the container ID included in the feature response.

24. The controller of claim 23, wherein the supported function includes at least an electronic programming guide, a tuner or a bookmark.

25. The controller of claim 23, wherein the control unit is further configured to receive a result of the browsing from the server through the interface unit.
